(19) United States
(12) Patent Application Publication
(10) Pub. No.: US 2025/0054369 A1
(43) Pub. Date: Feb. 13, 2025

(54) METHOD AND SYSTEM FOR CONDUCTING PROGRESSIVE WAGERING

(71) Applicant: Castle Island IP Holding LLC, Charlottesville, VA (US)

(72) Inventors: Daniel FULTON, Charlottesville, VA (US); Joshua LARSON, Charlottesville, VA (US); Brandon BOOKER, Charlottesville, VA (US); Jason SPRINKLE, Charlottesville, VA (US); Alan ROIREAU, Charlottesville, VA (US)

(21) Appl. No.: 18/798,011

(22) Filed: Aug. 8, 2024

Related U.S. Application Data
(60) Provisional application No. 63/532,280, filed on Aug. 11, 2023.
(60) Provisional application No. 63/622,678, filed on Jan. 19, 2024.

(51) Int. Cl. G07F 17/32

(52) U.S. Cl. CPC G07F 17/3258; G07F 17/3225

(57) ABSTRACT

Improved gaming systems, machines, devices, and methods are provided enabling variable gameplay using variable and/or dynamic reward values. The gaming system includes at least a gaming server and one or more gameplay stations, the gaming server determining a reward value in response to receiving a gameplay request and evaluating an award level of the gameplay request based on a progressive pool processing system, the reward value including at least a value based on one of a plurality of partitioned sections of one or more progressive pool(s).

### CROSS-REFERENCE TO RELATED APPLICATIONS

This application claims the benefit of and priority to U.S. Provisional Patent Application Ser. No. 63/532,280 filed on 11 Aug. 2023, and U.S. Provisional Patent Application Ser. No. 63/622,678 filed on 19 Jan. 2024, which applications are each expressly incorporated herein by reference in their entirety.

### FIELD OF THE DISCLOSURE

The field of the disclosure relates generally to gameplay stations, wagering terminals, and gaming servers, including gaming consoles, gaming machines or networked gaming machines, such as gameplay stations, wagering terminals, and gaming servers found in casinos or betting environments, and related methods of operation.

### BACKGROUND

Within the gambling or gaming industry, including sports betting, esports betting, games of chance, etc., traditional gaming machines include slot machines, poker machines, video lottery terminals, gaming consoles, and similar devices. These traditional gaming machines are configured to provide an interface for wagering on game events and have proven popularity. However, players quickly become tired of various adaptations of existing gaming machines, requiring the development of new and inventive ways to represent or play games on such gaming machines. For this reason, game creators must continually invent new and innovative ways to represent games and gameplay to stimulate players and encourage further interest.

Gaming or in other words, wagering, in the United States is generally categorized into class I, class II and class III for the purposes of regulation, with class I gaming being defined as traditional tribal gaming subject to the least regulation, and class III gaming being subject to the greatest regulation and broadly encompassing all forms of gaming that are neither class I or II (e.g. casino or table games such as slot machines, blackjack, craps, roulette, etc.).

Conventional class III gaming is generally based on a finite possibility of outcomes that allow a provider with an expected return over a large number of game plays. For example, a slot machine having a return to player calculation equal to 95% would be expected to payout on average approximately 95% of the amount wagered over a large number of game plays. As such, the provider can adjust required wager amounts and payout amounts based on the return to player calculation of the game in order to provide a predetermined revenue for the game as the number of plays increases and the law of large numbers takes effect.

In addition to conventional payouts, many class III games feature a progressive jackpot or payout that increases each time the game is played but the jackpot is not won. This may be accomplished but a predetermined amount being withdrawn from every wager for addition to the progressive jackpot, for example 1% of each wager placed, until the conditions for winning the progressive jackpot are met. When the progressive jackpot is won, the jackpot for the next play is reset to a predetermined value, often referred to as a seed, and the jackpot resumes increasing under the same rule. Often, multiple machines are pooled or linked together to form a larger progressive jackpot which may increase more quickly because more non-winning wagers can be applied to it.

Despite the popularity and success of current gaming methods, continued innovation has been hampered by financial and regulatory restrictions. Providers face several challenges in efforts to develop new and innovative ways to represent games and gameplay, with respect to both prevailing regulations and the need to ensure financial feasibility.

In view of the foregoing, there is a need for improved gaming systems and methods that improve gameplay and management of wagering games while easing compliance with existing regulations and providing a stable financial return. There is further a need for gaming systems and methods that enable the creation of new forms of gameplay, without increasing the processing requirements of a gaming terminal or gaming systems.

### SUMMARY

The embodiments disclosed herein are directed to providing improved gaming systems and methods that address the problems above and enable an advantage of improved variability and enjoyment in progressive pool gaming with reduced regulatory and processing constraints.

A gaming system is provided including one or more gameplay stations and a gaming server. The gameplay stations may include a user interface and the gaming server may be provided in network communication with the one or more gameplay stations through a communications interface. The gaming server may comprise a memory and a processor configured for executing instructions stored on the memory to perform the following steps: receiving a gameplay request from the one or more gameplay stations, evaluating the gameplay request based on partitioned award levels from one or more progressive pool(s), and determining a reward value for the gameplay request using the partitioned award levels and a progressive pool processing system, wherein the partitioned award levels include at least a value based on the one or more progressive pool(s) of the progressive pool processing system.

A method is provided comprising receiving a gameplay request from the one or more gameplay stations, evaluating the gameplay request based on partitioned award levels from one or more progressive pool(s), and determining a reward value for the gameplay request using the partitioned award levels and a progressive pool processing system, wherein the partitioned award levels include at least a value based on the one or more progressive pool(s) of the progressive pool processing system.

These and other features of the disclosure will become better understood by reference to the following description, appended claims, and accompanying drawings.

### BRIEF DESCRIPTION OF THE DRAWINGS

FIG. 1 is a diagrammatic view of a gaming system according to an embodiment of the disclosure.

FIG. 2 is a diagrammatic view of a gameplay station according to an embodiment of the disclosure.

FIG. 3 is a diagrammatic view of a gaming server according to an embodiment of the disclosure.

FIG. 4 is an illustration of a progressive pool according an embodiment of the present disclosure.

FIG. 5 is an illustration of a progressive pool processing system according an embodiment of the present disclosure.

FIG. 6 is an illustration of a progressive pool processing system according an embodiment of the present disclosure.

The figures are not necessarily drawn to scale, but instead are drawn to provide a better understanding of the components, and are not intended to be limiting in scope, but to provide exemplary illustrations. The figures illustrate exemplary configurations of a system and method for gaming, and in no way limit the structures, configurations, or methods of the system and method for gaming according to the present disclosure.

### DETAILED DESCRIPTION OF VARIOUS EMBODIMENTS

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. It should be understood, however, there is no intention to limit the disclosure to the specific embodiments disclosed, but on the contrary, the intention covers all modifications, alternative constructions, combinations, and equivalents falling within the spirit and scope of the disclosure.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

The disclosed embodiments relate to systems and methods for gaming that overcome the problems of static gameplay and rewards in existing gaming machines and provide an improved experience for players. The disclosure outlines some example improvements and practical applications provided by the disclosed embodiments. These are just examples only and the embodiments are not limited to only these improvements.

As referenced in the examples of the current disclosure, a “game,” “active game,” “existing game,” and/or “new game” may be used to refer to a set of parameters governing results of a wager.

Embodiments of a gaming system and related methods are provided for improving gameplay and management of progressive pool games without losing the regulatory advantages associated with house-banked gaming. Further, the creation of new forms of gameplay for progressive games is enabled, without increasing the processing requirements of a gaming terminal or gaming system.

The disclosed embodiments operate to improve how a gaming machine comprising a computing device operates and/or functions. For instance, the disclosed embodiments are able to automatically increase the variety and variability of rewards available for gaming while reducing management requirements by following the disclosed principles. Furthermore, the processing speed and operational efficiency of the gaming system can be improved. As a consequence, the disclosed embodiments operate to improve the computing efficiency and resource utilization of a gaming system and related computing architecture. As an additional example, by varying an entertaining display based on the reward values and the result of the player's wager, the disclosed embodiments will also improve the presentation of the game to a player.

The disclosed embodiments may be implemented in various configurations for gaming machines, gaming devices, or gaming systems, including but not limited to: (1) a dedicated gaming machine, gaming device, or gaming system wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

In embodiments, the computerized instructions for controlling games may be executed by at least one central server, central controller, or remote host. In such a “thin client” embodiment, the central server remotely controls any games (or other suitable interfaces) and the gaming machine is utilized to display such games (or suitable interfaces) and receive one or more inputs or commands from a player. In another embodiment, the computerized instructions for controlling games may be communicated from the central server, central controller, or remote host to a gaming machine's local processor and memory devices. In such a “thick client” embodiment, the gaming machine's local processor executes the communicated computerized instructions to control any games (or other suitable interfaces) provided to a player. In certain embodiments, a central server may comprise multiple servers to help with processing load.

Several (or different) elements discussed below, and/or claimed, are described as being “coupled”, “in communication with”, “in network communication”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, a specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be appreciated, however, that all of these or similar terms are to be associated with appropriate physical quantities and are merely convenient labels. Unless specifically stated otherwise, as apparent from the discussion herein, throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. In selected embodiments, the software, hardware, and associated components of the system may be programmed and configured to implement one or more embodiments described herein. The various aspects of the system may be exemplified as software, modules, nodes, etc. of a computer or server device.

This disclosure builds on concepts related to those described in U.S. Provisional Patent Application No. 63/524,560 filed on 30 Jun. 2023 by the same Applicant, and U.S. application No. 18,761,005, filed Jul. 1, 2024 also by the same Applicant, which claims priority to U.S. Provisional Patent Application No. 63/524,560. Both U.S. Provisional Patent Application No. 63/524,560 and United States Application No. 18,761,005 are expressly incorporated herein by reference.

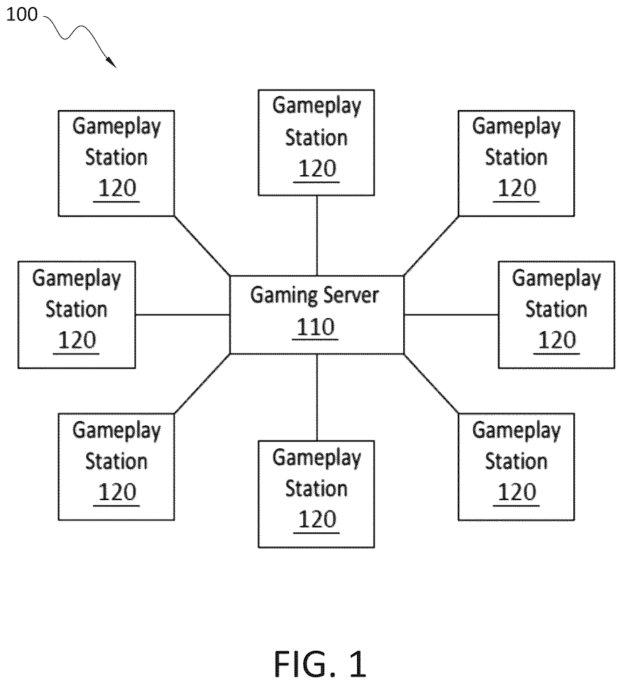

FIG. 1 illustrates an embodiment of a gaming system 100 including a gaming controller 110 in communication with a plurality of gameplay stations 120 for enabling players to participate in gaming. The gaming system 100 may be configured to provide the gaming controller 110 and the plurality of gameplay stations 120 in the same general location or may be configured to provide the gaming controller 110 and the plurality of gaming stations 120 in remote locations.

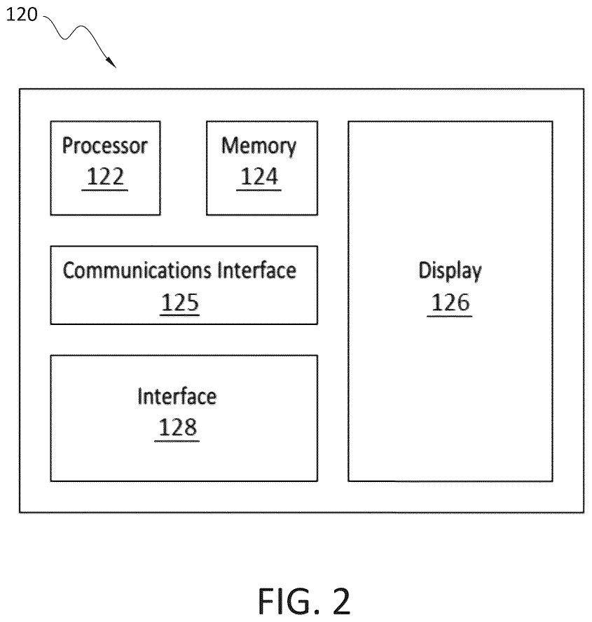

As illustrated in FIG. 2, each of the plurality of gameplay stations 120 may include at least one processor 122 and at least one memory 124 for operating a corresponding display 126 and a corresponding user interface 128. The memory 124 may comprise a non-transitory computer readable medium that stores program code and instructions, executable by the processor 122, to control the gameplay station 120. In operation, each gameplay station 120 is arranged to facilitate an input by a player, such that a corresponding gameplay request is sent by a communications interface 125 from the gameplay station 120 to the gaming server 110. The user interface 128 may include a keyboard, touch screen, card reader or other value receiving device, speakers, microphones, or any other suitable or related components.

The user interface 128 may include at least one payment device in communication with the processor 122. The payment device may be a payment acceptor including a note, ticket or bill acceptor wherein the player inserts paper money, a ticket, or voucher, and/or a coin slot where the player inserts money, coins, or tokens. In other embodiments, other payment devices such as readers or validators for credit cards, debit cards, identification cards, credit slips, or related data carriers may accept payment. It should be appreciated that, when a player funds the gameplay station 120, the processor 122 determines the amount of funds entered and incorporates the funds into a corresponding gameplay request.

The gameplay station 120 can incorporate any suitable wagering game and may include some or all of the features of conventional gaming machines or devices.

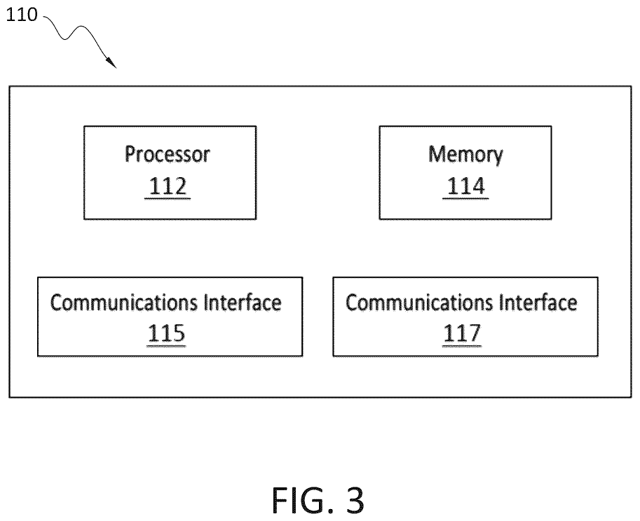

An embodiment of a gaming controller 110 is shown in FIG. 3, including a processor 112, a memory 114 and a communications interface 115, for managing one or more games or gameplay requests thereon. The gaming controller 110 may be configured for receiving a gameplay request of a gameplay station 120 by means of the communications interface 115 and managing the gameplay request.

In these embodiments, the processor 122 of each gameplay station 120 may be designed to transmit and receive events, messages, commands, or any other suitable data or signal between the individual gameplay station 120 and the gaming controller 110. The gameplay station 120 processor 122 is operable to execute such communicated events, messages, or commands in conjunction with the operation of the gameplay station 120. Moreover, the processor 112 of the gaming controller 110 may be designed to transmit and receive events, messages, commands, or any other suitable data or signal between the gaming controller 110 and each of the individual gameplay stations 120. The processor 112 of the gaming controller 110 may be operable to execute such communicated events, messages, or commands in conjunction with the operation of the gaming controller 110.

According to another aspect of the disclosure, the communications interface 115 of the gaming controller 110 and/or the communications interface 125 of the gameplay stations 120 may facilitate only a local connection, or may be provided as local communications interfaces, such that the use of an internet connection, internet service provider (ISP) or other third-party data connection is not required for communications between the gaming controller 110 and the plurality of gameplay stations 120. In various embodiments, the communications interfaces 115, 125 may be restricted to short distance communications.

According to various embodiments, the gaming controller 110 may be provided with a communications interface 117 for remote management, maintenance or monitoring of the gaming system 100 and/or the communications interface 125 of the gameplay stations 120 may facilitate a local connection or may be provided as local communications interfaces. For example, communications interface 115, 117, 125 may include an internet connection or other third-party data connection, such as for processing payments made by a player or for other communications.

In some embodiments, the gaming controller 110 and/or the gameplay stations 120 are capable of being connected together through a data network. In one embodiment, the data network is a local area network (LAN), in which one or more of the gaming machines 60 are substantially proximate to each other and an on-site central server or controller as in, for example, a gaming establishment or a portion of a gaming establishment. In another embodiment, the data network is a wide area network (WAN) in which one or more of the gaming machines are in communication with at least one off-site central server or controller. In this embodiment, the gaming controller 110 and/or the gameplay stations 120 may be located in a different part of the gaming establishment or within a different gaming establishment than the off-site central server or controller. Thus, the WAN may include an off-site central server or controller and an off-site gameplay station located within gaming establishments in the same geographic area, such as a city or state. The WAN gaming system may be substantially identical to the LAN gaming system described above, although the number of gameplay stations in each system may vary relative to one another. In another embodiment, the data network may comprise a wide area progressive (WAP) or cloud-based network.

In another embodiment, the data network may include the internet or an intranet. For example, operation of the gaming controller 110 and/or the gameplay stations 120 may be viewed at the gaming controller 110 and/or the gameplay stations 120 using at least one internet browser implemented thereon. In this embodiment, operation of the gaming controller 110 and/or the gameplay stations 120 and accumulation of credits may be accomplished with only a connection to the central server or controller (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. The enhanced bandwidth of digital wireless communications may render such technology suitable for some or all communications, particularly if such communications are encrypted. Higher data transmission speeds may be useful for enhancing the sophistication and response of the display and interaction with the player.

Embodiments may be employed in a server-based gaming system. In one such embodiment, one or more gameplay stations 120 are in communication with a gaming controller 110 in the form of a central server. The central server may be any suitable server or computing device which includes at least one processor and a memory or storage device. In various embodiments, the central server may be a progressive controller or another gaming machine in the gaming system.

According to alternative embodiments, the gameplay stations 120 and the gaming controller 110 may be implemented in a single computing system, such that the gameplay stations 120 are integrated into a single device with or without the gaming controller 110 also implemented thereon. In integrated embodiments, the gaming controller 110 and the gameplay stations 120 may be operated using the same processor and/or the same memory with a plurality of user interfaces 128 and/or communications interfaces 115, 117, 125.

It is noted that one, more or each of the functions of a gaming controller, gaming server, central controller, central server or remote host as disclosed herein may be performed by one or more gameplay stations, such as by one or more processors of one or more gameplay stations. It is further noted that one, more or each of the functions of one or more gameplay stations as disclosed herein may be performed by the gaming controller, gaming server, central controller, central server or remote host.

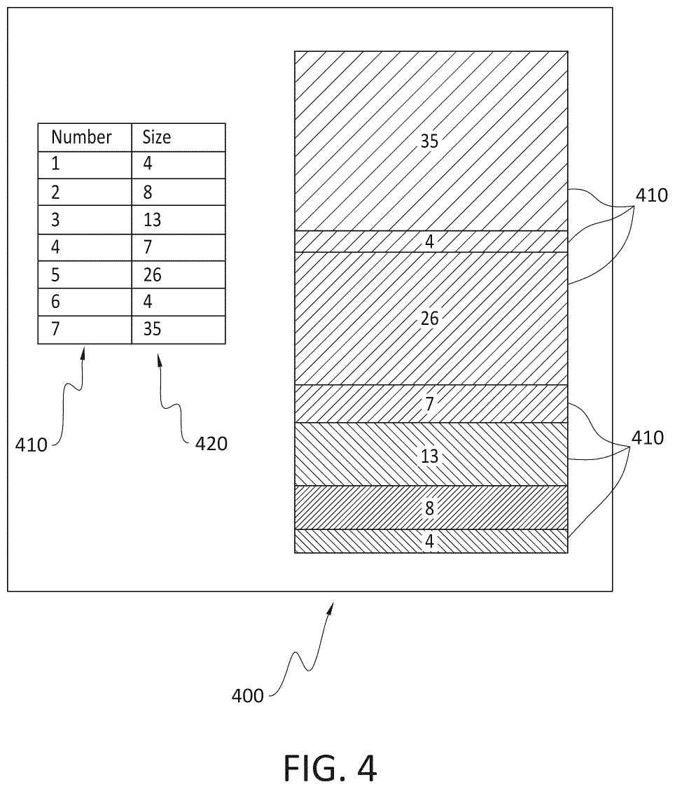

Embodiments of the disclosure may be directed to wagering games facilitated by a progressive pool 400, as illustrated in FIG. 4. A progressive pool 400 according to the present disclosure may comprise an account or value accumulated from player wagers made at one or more gameplay stations. The progressive pool may be managed by a progressive pool processing system, such as to accept portions of wager values, distribute wager rewards, etc.

Accordingly, the gaming controller 110 may comprise a progressive controller, such that the gaming controller 110 manages gameplay requests received from the gameplay stations 120. Each gameplay request provided from a gameplay station 120 may include a wager. The player may initiate gameplay and may place a wager by any suitable method, such as by transferring money or credits to the gaming system 100. In varying forms of the gaming system, the player may select a predefined wager or enter a custom wager using the user interface 128, for example by means of a card reader or other reader for receiving objects of value. At least one or a plurality of input devices of the gaming system 100 may be used to facilitate the wager and the gaming system 100 may accept and/or process the wager.

In one aspect of the disclosure, the gaming controller 110 of the system 100 may include databases, terminals, and/or computing devices to manage a progressive pool in a wagering environment. In certain aspects, the gaming controller 110 may employ a progressive processing system for accepting and processing wagers of one or more players, making progressive pool allocations, calculating odds and prices of wagers, calculating the commission for the operator, and distributing winnings. Rewards may be distributed to players based on a predetermined paytable with specified award levels that are associated with the progressive pool of the progressive processing system.

One area of particular difficulty in the gaming industry is budgeting, due in large part to the management of wagers and payouts being based on probabilities. These probabilities can result in highly volatile profits and losses, especially in the short term or during periods of low player numbers. The progressive pool according to the current disclosure may advantageously eliminate this difficulty by providing a progressive pool for managing wagers using a commission-based revenue arrangement. In such an arrangement, revenue is stabilized by setting a commission value for each wager, where the remainder of the wager is applied to the progressive pool from which player rewards are derived. For example, if a provider commission was set to 5% and a wager of $10 was made, the provider would retain $0.50 as direct revenue, while the remaining $9.50 would be added to the progressive pool and available for distributing to players for winning wagers.

In some aspects, the gaming controller 110 may maintain partitioned levels 410 within the progressive pool for different wager denominations, different specified gameplay results, and the like. The partitioned levels 410 of the progressive pool may correlate to different award levels or rates 420, such that the award levels may be used to partition one or more progressive pool(s) into a plurality of sections 410. The partitioned levels 410 of the progressive pool may be correlated levels, such that all levels 410 of the progressive pool are impacted by wins and losses of the players at each of the gameplay stations. This arrangement advantageously increases variability and player interest, as every wager is impacted by any wins and losses that occur, even by other players. Likewise, the reward value for every level may be increased quickly, as every wager made contributes directly to the progressive pool and can impact every available reward.

In the depicted embodiment of FIG. 4, a single progressive pool 400 is shown that is partitioned into seven sections or levels 410. Each of the sections has a size 420 defined as the percent of the pool allocated for that section. For example, if the progressive pool's total value was $1,000, then section “2” of the pool would have a size of $80 ($1,000*0.08). Section “2” of the pool may be associated with a predetermined game or paytable award, for example a payline of a slot machine. Extrapolating the current example to include additional possible payouts of a slot machine and/or other gaming machines or terminals, the progressive pool may be partitioned into only a few levels up to hundreds, thousands, tens of thousands, hundreds of thousands or even more levels, while still retaining the advantage of only managing a single progressive pool.

The use of one or more progressive pool(s) with multiple partitioned sections enables several additional advantages over the prior art in view of the regulatory constraints that exist for such progressive pools. For example, common regulations require close monitoring and reporting of progressive pool fund records, including preparation of an at least weekly progressive summary recording the amount of the progressive pool and a daily accounting calculation of the amount that should be displayed to players. These reports must be prepared by designated individuals, be signed and verified, and properly submitted to regulatory agencies. Where multiple progressive pools are used in conventional systems, with a distinct progressive pool for each possible award, the labor costs of preparing these thousands to hundreds of thousands of reporting values is extremely burdensome. This burden is dramatically reduced by embodiments of the current disclosure having a partitioned progressive pool, meaning only a single value for the progressive pool must be reported while multiple awards are enabled by the use of a nearly limitless number of sections being partitioned in the same progressive pool.

The gaming controller may be arranged to dynamically determine a reward value associated with a wager result based on the award level of the wager result and a value of the progressive pool. An award level may be associated with a particular game, particular gameplay result, etc., although other arrangements are considered where the award levels correspond with a number of wins in a row, where the award rates correspond with a wager level or value, where one or more minimum award values are zero, where the minimum award values are only used when the minimum value is greater than a reward value based on the award rate alone, where the minimum award value is a dynamic value, or another arrangement for determining dynamic rewards. The gaming controller may identify the award level of the specified wager result and identify the one or more award rates associated with the award level.

The gaming controller may be arranged to dynamically determine a reward value associated with a given wager result based on an award level of the wager result having a variable size value and a value of the progressive pool in a tier system. Rather than using a static rate for determining reward values associated with a given outcome as the progressive pool value increases or decreases, the dynamic determination of the reward value according to the present disclosure may change distribution rates for each award level based on the total progressive pool value by dividing the total progressive pool value into tier levels having predetermined values.

The tier levels of the progressive pool may be arranged to divide the total progressive pool value into ranges of values that fill progressively. Each wager result may be associated with an award level having a minimum award value and a plurality of award rates corresponding to each of the tier levels, such that the marginal rate of a reward varies as the total pool value increases or decreases. When a winning wager result occurs, the processor of the controller may identify the award level of the wager result and divide the pool value into the tier levels. The reward value for the wager result may comprise the minimum award value of the award level and a plurality of tier level values determined by applying the plurality of award rates of the award level to each of the corresponding tier levels.

By varying the award rates for the wager results, or award levels, as the total progressive pool value increases a player is continuously presented with changing gameplay reflective of the wagers of other players that pay into the progressive pool. The varying rates of the award levels can increase the relative value of different wager results and motivate the player to change the objective of their wager, depending on the total progressive pool value and the associated tier levels.

The use of the tier levels also enables the gaming system to use a single progressive pool for the plurality of award levels rather than forming a plurality of pools associated with each award level or wager result. In existing systems, varying award rates are only accomplished by creating multiple pools but these pools are independent and a wager may only be applied to one of the multiple pools, resulting in slower, static growth of the pool values across a variety of wagers and a less dynamic system. Slower, static growth reduces the number of viable wager types and restricts the variability of gameplay available to players.

In some embodiments of the disclosure, the tier levels may be selected to create increasing variation in marginal rewards as the total progressive pool increases, incentivizing variability in gameplay as the stakes and number of players increase. Alternatively, the tier levels may change quickly at low total progressive pool values in order to incentivize more wagers and more quickly grow the progressive pool.

Furthermore, the processing speed and operational efficiency of the gaming system can be improved by dividing one or more progressive pool(s) into a plurality of tier levels, because the device is not required to maintain separate progressive pools for different wager types or results. As a consequence, the disclosed embodiments operate to improve the computing efficiency and resource utilization of a gaming system and related computing architecture.

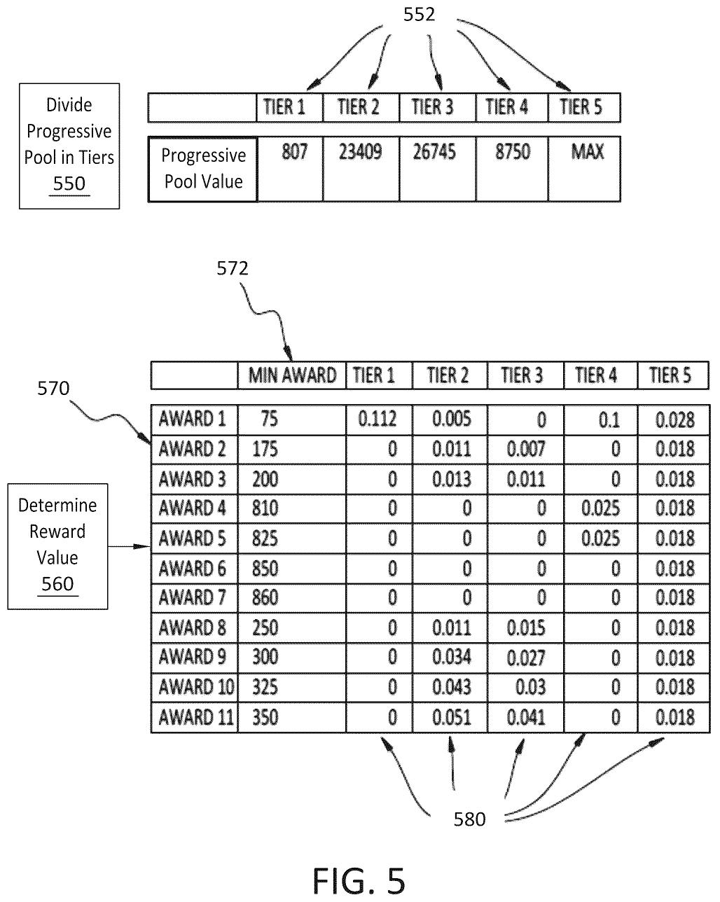

The gaming controller may be arranged to dynamically determine the reward value associated with a wager result based on an award level associated with the wager result. In an example illustrated in FIG. 5, the gaming controller divides the total progressive pool value into a plurality of tier levels 552 having predetermined values 550. The tier levels 552 may be filled progressively as value is added to the progressive pool, such that a first tier is filled prior to filling a second tier.

According to the example of FIG. 5, a pool value of 55,555, for example 55,555 dollars, points or another value representation, may break down into 5 tiers with tier 1=807; tier 2=23409; tier 3=26745; tier 4=4594; and tier 5=0. In some embodiments, the tier levels 552 may be selected with each tier level having a different size, such as a decreasing size at higher tier levels. A decreasing size at higher tier levels allows higher variability in the number of tier levels 552 filled as the total pool increases, incentivizing variability in gameplay as the stakes and number of players increase. Alternatively, the tier levels 552 may have an increasing size at higher tier levels, causing more variability at low total progressive pool values in order to incentivize more wagers and more quickly grow the progressive pool.

In determining the reward value 560 according to the embodiment of FIG. 5, each specified wager result may be associated with an award level 570 having a minimum award value 572 and one or more award rates 580, such that the marginal rate of a reward may vary as the total progressive pool value increases or decreases.

The reward value for the specified wager result of the paytable may comprise the minimum award value 572 of the award level 570 and one or more additional values determined by applying the one or more award rates 580 of the award level 570 to the one or more progressive pool(s). The reward value may be described as equal to (Min Award)+Σ_{N=1}^{MaxTierNumber}(ValueOfTierN)*(AwardsRateOfTierN). In other embodiments, the reward value for the specified wager result may comprise the minimum award value 572 of the award level 570 or one or more additional values determined by applying the one or more award rates 580 of the award level 570 to the progressive pool.

In the example of FIG. 5, a reward value based on a wager result having an award level 570 equal to AWARD 8 may be determined as =(250)+(807)*(0)+(23409)*(0.011)+(26745)*(0.015)+(4594)*(0)+(0)*(0.018)=908. It is noted that the example of FIG. 5 is merely exemplary, and the minimum awards, award rates and award levels may be rearranged, added to, included or excluded, and otherwise modified within the spirit and scope of the disclosure.

Rather than using a static rate for determining reward values associated with a given outcome as the progressive pool value increases or decreases as implemented in existing gaming machines, the dynamic determination of the reward value according to the present disclosure allows for changes in a marginal rate for each award level based on the total progressive pool value by dividing the total progressive pool value into tier levels having predetermined values. The dynamic determination of the reward value advantageously introduces new variation into gameplay without increasing processing requirements, and can increase player engagement, enjoyment and participation. In like manner, the dynamic determination of the reward values increases the control of a provider over the progressive pool value, such that automatic variations in reward values can be implemented to increase player engagement and maintain necessary progressive pool reserves.

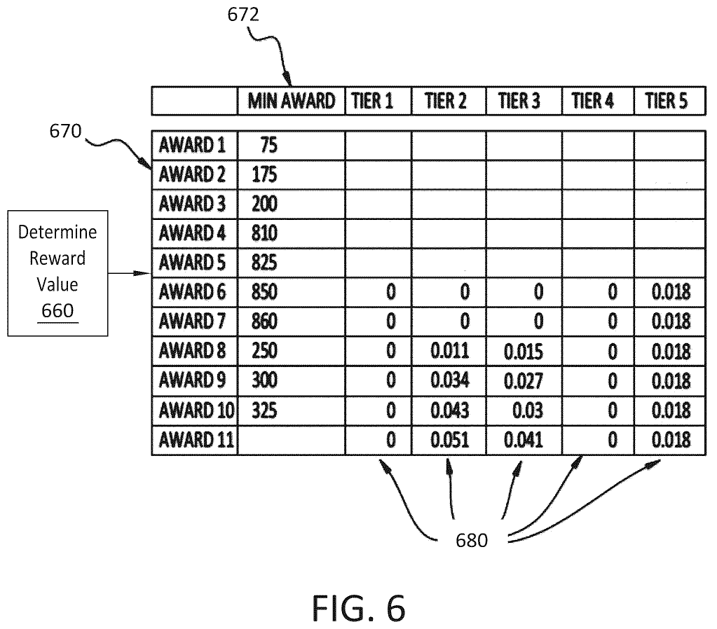

According to varying aspects of the disclosed embodiments, only certain award levels or rates may be enabled based on one or more of a player's choice, a wager value, or a predetermined wager result from the paytable. In the example of FIG. 6, a reward value 660 may be determined based on award levels 670 representing a mixture of static, static and variable, and only variable reward values. According to the depicted example, award levels 1-5 provide only a static reward value based on the minimum award 672 without any variable award rates, while award levels 6-10 provide both a static reward based on the minimum award 672 and a variable reward based on the award rates 680, and award level 11 provides only a variable reward based on the award rates 680. Such a varied approach to reward values can allow for greater excitement and variability in a game, enabling a player to pursue a particular wager result based on the respective reward value and/or enabling a provider to advertise a larger reward value for certain wager results or games, to attract more players to the game. In varying embodiments, the minimum award values may be dynamic values, or may be a combination of dynamic and static values, or some minimum award values may be static while other minimum award values may be dynamic. Different arrangements and combinations of static and dynamic or variable rewards may be used, and the example of FIG. 6 is only illustrative of principles thereof.

As mentioned, only certain award levels or rates may be enabled based on one or more of a player's choice, a wager value, or a predetermined set of wager results. For example, certain wager values and/or denominations may be associated with enabling different award levels for the player's wager. In like manner, a game may be adjusted by a provider and/or by a player's choice to associate certain award levels with static and/or variable rewards based on the wager result associated with that award level in the paytable.

These dynamic rewards and engaging variations in gameplay for players are advantageously realized while surprisingly increasing predictability for the provider. This is due to the dynamic rewards being based on a progressive pool and commission-based revenue system as discussed above, rather than requiring rewards completely funded by the house or provider, meaning that the provider can set a rake or commission based on one or more of a player's wager value, a progressive pool value, and a reward value. This means that a value of the provider's rake or commission can be readily predicted or estimated based only on the number of players and/or games played, such as independent of wager odds for the game as would occur for static reward values alone.

In addition to adding predictability, methods of the current disclosure further ensure a profit for the provider by eliminating the possibility of a game where the provider is responsible for payment of a win beyond the progressive pool values. In the prior art, a chance exists that a provider may have an “upside-down” game, where the provider owes payouts to players that can not only diminish the provider's commission but require the provider to pay additional funds beyond their commission, thus operating at a loss. This can occur when players win early or close together, meaning that a provider must pay winnings before revenue has grown to suitable levels. In contrast to the prior art, the methods of the current disclosure eliminate the chance of an “upside-down” game where the provider would not only make no profit from operating the game but also be responsible for payment of additional funds, i.e., incurring a loss for operating the game.

The progressive pool processing system may be configured to charge a rake or commission but is also able to accommodate a secondary rake or commission (and/or 3^{rd}, 4^{th}, etc.) as needed or desired by a provider. The rake or commission may be set to be a percentage of the total wagers placed but may also be configured to be or include a portion from rounding of player reward values. This advantageously results in a constant profit for the provider. For example, if a commission rate is set to 5% one can quickly predict that, with no variability, for every $100 wagered on the gaming system the provider will be paid $5 in commission. This allows for greatly improved planning of game placement and budgeting activities of the provider relative to prior art systems.

In some embodiments, the progressive pool processing system may be configured to charge a seed rake for reseeding the progressive pool. After a progressive jackpot is won or upon the initialization of a progressive jackpot, a value of the jackpot would be effectively at a zero value because no wagers have been made to apply value to the pool. In conventional systems, the house or provider of the jackpot therefore adds a seed value to reset the progressive jackpot to a predetermined minimum value. These seed values have represented a necessary, but burdensome, cost for providers of progressive jackpots. However, embodiments of the current disclosure may do away with or substantially reduce the need for the provider to provide seed values by applying a seed rake to each wager placed.

The seed rake may represent a percentage value or the like applied to the wager, and the value of the seed rake may be applied to a seed reserve, while the provider commission is applied to the provider's revenue and the remaining value of the wager is applied to the progressive pool. For example, a seed rake may comprise 1% of a wager, a provider commission may comprise 5% of the wager, and the remaining 94% of the wager may be added to the progressive pool.

The seed reserve may then grow at a predetermined rate to provide a seed value for the progressive pool when a value of the progressive pool drops below a preset minimum threshold. Advantageously, the seed rake and seed reserve allow a provider to avoid or at least minimize the cost of resetting the progressive pool. In certain embodiments, the seed reserve may be capped at a predetermined value, such as two-or three-times a reset value of the progressive pool, or another value. After the seed reserve hits the predetermined cap value, the seed rake may no longer be taken from the wager or may be applied to the progressive pool in place of the seed reserve.

The gaming system may create and/or select an entertaining display corresponding to the wager result. The entertaining display may break the value won into multiple animations or bonus games. Breaking the value won into multiple animations or bonus games can increase the enjoyment and successful feeling of the player and encourage continued gaming.

In some embodiments, the entertaining display may include a separate component (not shown), such as a separate display screen or mechanical element. The separate components may include a video display, window or a mechanical element corresponding to a plurality of possible results of the player's wager. During the presentation of the entertaining display, a portion of the gaming device may remain dedicated to illustrating features of the progressive pool. In some examples, a reward value map for determining the reward value may act similar to a random number generator call, pointing to a set of reel stops, e.g., for a reel-based slot machine.

The entertaining display may be based on a theme or a secondary game. The theme or secondary game may be selected by a player based on preference and/or may be manipulated by the processor in response to a particular wager result and/or a reward value available for a wager. The theme or secondary game may include accompanying depictions and animated highlights of a winning game as the participants complete the wager. The entertaining display may include matches with graphics, symbols, and other indicia particular to the theme or the secondary game.

The wager may end with a payout, beginning another wager, another round, a bonus game, and/or by reverting to a menu providing additional options for the player.

By providing a gaming system and method for using the same according to the disclosed embodiments, the requirements of existing gaming systems including static reward values, burdensome reporting requirements for multiple progressives, and unpredictable earnings for providers are addressed. The gaming system embodiments provided herein advantageously allow a prospective player to play a wagering game with variable and dynamic reward values, thereby increasing a player's enjoyment of the game generally, while meeting the regulatory requirements of progressive pools and gaining the advantages of commission-based revenue.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

Accordingly, features of the disclosed embodiments may be combined or arranged for achieving particular advantages as would be understood from the disclosure by one of ordinary skill in the art. Similarly, features of the disclosed embodiments may provide independent benefits applicable to other examples not detailed herein.

It is to be understood that not necessarily all objects or advantages may be achieved under any embodiment of the disclosure. Those skilled in the art will recognize that the disclosed gaming system and related methods may be embodied or carried out in a manner that achieves or optimizes one advantage or group of advantages as taught without achieving other objects or advantages as taught or suggested.

The skilled artisan will recognize the interchangeability of various disclosed features. Besides the variations described, other known equivalents for various features can be mixed and matched by one of ordinary skill in this art to make or use a gaming system and related methods under principles of the present disclosure. It will be understood by the skilled artisan that the features described may be adapted to other types of systems, games and regulatory requirements.

Although this disclosure describes certain exemplary embodiments and examples of a gaming system and related methods, it will be understood by those skilled in the art that the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

1-1. A gaming system comprising:
one or more gameplay stations, the gameplay stations including a user interface; and
a gaming server in communication with the one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on partitioned award levels from one or more progressive pool(s); and
determine a reward value for the gameplay request using the partitioned award levels and a progressive pool processing system;
wherein the partitioned award levels include at least a dynamic value based on the one or more progressive pool(s) of the progressive pool processing system.

1-2. The gaming system of any one or a combination of two or more of 1-1 above and 1-3 to 1-10 below,
wherein the gameplay request comprises at least a wager value, and
wherein a provider commission is removed from the wager value and a remaining value of the wager value is applied to the one or more progressive pool(s).

1-3. The gaming system of any one or a combination of two or more of 1-1 to 1-2 above and 1-4 to 1-10 below, wherein the award levels comprise a percentage value of the one or more progressive pool(s).

1-4. The gaming system of any one or a combination of two or more of 1-1 to 1-3 above and 1-5 to 1-10 below, wherein the award levels comprise a percentage value of the one or more progressive pool(s) and a static minimum reward.

1-5. The gaming system of any one or a combination of two or more of 1-1 to 1-4 above and 1-6 to 1-10 below, wherein the progressive pool processing system provides a seed reserve in addition to the progressive pool.

1-6. The gaming system of any one or a combination of two or more of 1-1 to 1-5 above and 1-7 to 1-10 below, wherein a seed rake is removed from the wager value, a provider commission is removed from the wager value and a remaining value of the wager value is applied to the one or more progressive pool(s).

1-7. The gaming system of any one or a combination of two or more of 1-1 to 1-6 above and 1-8 to 1-10 below, wherein the seed reserve is capped at a predetermined value.

1-8. The gaming system of any one or a combination of two or more of 1-1 to 1-7 above and 1-9 to 1-10 below, wherein the progressive pool processing system is configured to extract a predetermined commission value from at least one of the wager value, the one or more progressive pool(s), and the reward value.

1-9. The gaming system of any one or a combination of two or more of 1-1 to 1-8 above and 1-10 below, wherein the one or more progressive pool(s) is partitioned into a plurality of tier levels.

1-10. The gaming system of any one or a combination of two or more of 1-1 to 1-9 above, wherein each award level includes a plurality of award rates corresponding to each of the plurality of tier levels, such that the determination of the reward value includes a value from each of the plurality of tier levels determined by the plurality of award rates for the award level. 1-11. A method for conducting games, comprising:
receiving a gameplay request from one or more gameplay stations;
evaluating the gameplay request based on partitioned award levels from one or more progressive pool(s); and
determining a reward value for the gameplay request using the partitioned award levels and a progressive pool processing system;
wherein the partitioned award levels include at least a value based on the one or more progressive pool(s) of the progressive pool processing system.

1-12. The method of any one or a combination of two or more of 1-11 above and 1-13 to 1-20 below, wherein the gameplay request comprises at least a wager value, and
wherein a provider commission is removed from the wager value and a remaining value of the wager value is applied to the one or more progressive pool(s).

1-13. The method of any one or a combination of two or more of 1-11 to 1-12 above and 1-14 to 1-20 below, wherein the award levels comprise a percentage value of the one or more progressive pool(s).

1-14. The method of any one or a combination of two or more of 1-11 to 1-13 above and 1-15 to 1-20 below, wherein the award levels comprise a percentage value of the one or more progressive pool(s) and a static minimum reward.

1-15. The method of any one or a combination of two or more of 1-11 to 1-14 above and 1-16 to 1-20 below, wherein the progressive pool processing system provides a seed reserve in addition to the progressive pool.

1-16. The method of any one or a combination of two or more of 1-11 to 1-15 above and 1-17 to 1-20 below, wherein a seed rake is removed from the wager value, a provider commission is removed from the wager value and a remaining value of the wager value is applied to the one or more progressive pool(s).

1-17. The method of any one or a combination of two or more of 1-11 to 1-16 above and 1-18 to 1-20 below, wherein the seed reserve is capped at a predetermined value.

1-18. The method of any one or a combination of two or more of 1-11 to 1-17 above and 1-19 to 1-20 below, wherein the progressive pool processing system is configured to extract a predetermined commission value from at least one of the wager value, the one or more progressive pool(s), and the reward value.

1-19. The method of any one or a combination of two or more of 1-11 to 1-18 above and 1-20 below, wherein the one or more progressive pool(s) is partitioned into a plurality of tier levels.

1-20. The method of any one or a combination of two or more of 1-11 to 1-19 above, wherein each award level includes a plurality of award rates corresponding to each of the plurality of tier levels, such that the determination of the reward value includes a value from each of the plurality of tier levels determined by the plurality of award rates for the award level.

1-21. A gaming system comprising:
a gaming server in communication one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on partitioned award levels from one or more progressive pool(s); and
determine a reward value for the gameplay request using the partitioned award levels and a progressive pool processing system;
wherein the partitioned award levels include at least a dynamic value based on the one or more progressive pool(s) of the progressive pool processing system.

1-22. The gaming system of any one or a combination of two or more of 1-21 above and 1-23 to 1-31 below,
wherein the gameplay request comprises at least a wager value, and
wherein a provider commission is removed from the wager value and a remaining value of the wager value is applied to the one or more progressive pool(s).

1-23. The gaming system of any one or a combination of two or more of 1-21 to 1-22 above and 1-24 to 1-31 below, wherein the award levels comprise a percentage value of the one or more progressive pool(s).

1-24. The gaming system of any one or a combination of two or more of 1-21 to 1-23 above and 1-25 to 1-31 below, wherein the award levels comprise a percentage value of the one or more progressive pool(s) and a static minimum reward.

1-25. The gaming system of any one or a combination of two or more of 1-21 to 1-24 above and 1-26 to 1-31 below, wherein the progressive pool processing system provides a seed reserve in addition to the progressive pool.

1-26. The gaming system of any one or a combination of two or more of 1-21 to 1-25 above and 1-27 to 1-31 below, wherein a seed rake is removed from the wager value, a provider commission is removed from the wager value and a remaining value of the wager value is applied to the one or more progressive pool(s).

1-27. The gaming system of any one or a combination of two or more of 1-21 to 1-26 above and 1-28 to 1-31 below, wherein the seed reserve is capped at a predetermined value.

1-28. The gaming system of any one or a combination of two or more of 1-21 to 1-27 above and 1-29 to 1-31 below, wherein the progressive pool processing system is configured to extract a predetermined commission value from at least one of the wager value, the one or more progressive pool(s), and the reward value.

1-29. The gaming system of any one or a combination of two or more of 1-21 to 1-28 above and 1-30 to 1-31 below, wherein the one or more progressive pool(s) is partitioned into a plurality of tier levels.

1-30. The gaming system of any one or a combination of two or more of 1-21 to 1-29 above and 1-31 below, wherein each award level includes a plurality of award rates corresponding to each of the plurality of tier levels, such that the determination of the reward value includes a value from each of the plurality of tier levels determined by the plurality of award rates for the award level.

1-31. The gaming system of any one or a combination of two or more of 1-21 to 1-30 above, wherein the award levels comprise a percentage value of the one or more progressive pool(s) and a static minimum reward.

1-32. A storage device having instructions stored thereon, which, when executed by one or more processors of a gaming system, configure the one or more processors to perform the method of any one or a combination of two or more of 1-11 to 1-20 above.

1-33. A gaming device comprising:
a memory; and
a processor
the gaming device being configured to communicate with one or more gameplay stations through a communications interface,
the gaming device configured to execute instructions stored on the memory to perform the following steps:
receiving a gameplay request from at least one of the one or more gameplay stations;
evaluating the gameplay request based on partitioned award levels from one or more progressive pool(s); and
determining a reward value for the gameplay request using the partitioned award levels and a progressive pool processing system;
wherein the partitioned award levels include at least a dynamic value based on the one or more progressive pool(s) of the progressive pool processing system.

1-34. The gaming device according to 1-33, wherein the gaming device itself is a gameplay station in communication with other gameplay stations.

1-35. A gaming device comprising:
a memory;
a processor; and
a user interface;
wherein the gaming device is configured to execute instructions stored on the memory to perform the following steps:
receive a gameplay request;
evaluate the gameplay request based on partitioned award levels from one or more progressive pool(s); and
determine a reward value for the gameplay request using the partitioned award levels and a progressive pool processing system;
wherein the partitioned award levels include at least a dynamic value based on the one or more progressive pool(s) of the progressive pool processing system.

2-1. A gaming system comprising:
one or more gameplay stations, the gameplay stations including a user interface; and
a gaming server in communication with the one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on partitioned award levels from a single progressive pool; and
determine a reward value for the gameplay request using the partitioned award levels and a progressive pool processing system;
wherein the partitioned award levels include at least a dynamic value based on the single progressive pool of the progressive pool processing system.

2-2. The gaming system of any one or a combination of two or more of 2-1 above and 2-3 to 2-10 below,
wherein the gameplay request comprises at least a wager value, and
wherein a provider commission is removed from the wager value and a remaining value of the wager value is applied to the single progressive pool.

2-3. The gaming system of any one or a combination of two or more of 2-1 to 2-2 above and 2-4 to 2-10 below, wherein the award levels comprise a percentage value of the single progressive pool.

2-4. The gaming system of any one or a combination of two or more of 2-1 to 2-3 above and 2-5 to 2-10 below, wherein the award levels comprise a percentage value of the single progressive pool and a static minimum reward.

2-5. The gaming system of any one or a combination of two or more of 2-1 to 2-4 above and 2-6 to 2-10 below, wherein the progressive pool processing system provides a seed reserve in addition to the progressive pool.

2-6. The gaming system of any one or a combination of two or more of 2-1 to 2-5 above and 2-7 to 2-10 below, wherein a seed rake is removed from the wager value, a provider commission is removed from the wager value and a remaining value of the wager value is applied to the single progressive pool.

2-7. The gaming system of any one or a combination of two or more of 2-1 to 2-6 above and 2-8 to 2-10 below, wherein the seed reserve is capped at a predetermined value.

2-8. The gaming system of any one or a combination of two or more of 2-1 to 2-7 above and 2-9 to 2-10 below, wherein the progressive pool processing system is configured to extract a predetermined commission value from at least one of the wager value, the single progressive pool, and the reward value.

2-9. The gaming system of any one or a combination of two or more of 2-1 to 2-8 above and 2-10 below, wherein the single progressive pool is partitioned into a plurality of tier levels.

2-10. The gaming system of any one or a combination of two or more of 2-1 to 2-9 above, wherein each award level includes a plurality of award rates corresponding to each of the plurality of tier levels, such that the determination of the reward value includes a value from each of the plurality of tier levels determined by the plurality of award rates for the award level.

2-11. A method for conducting games, comprising:
receiving a gameplay request from one or more gameplay stations;
evaluating the gameplay request based on partitioned award levels from a single progressive pool; and
determining a reward value for the gameplay request using the partitioned award levels and a progressive pool processing system;
wherein the partitioned award levels include at least a value based on the single progressive pool of the progressive pool processing system.

2-12. The method of any one or a combination of two or more of 2-11 above and 2-13 to 2-20 below, wherein the gameplay request comprises at least a wager value, and
wherein a provider commission is removed from the wager value and a remaining value of the wager value is applied to the single progressive pool.

2-13. The method of any one or a combination of two or more of 2-11 to 2-12 above and 2-14 to 2-20 below, wherein the award levels comprise a percentage value of the single progressive pool.

2-14. The method of any one or a combination of two or more of 2-11 to 2-13 above and 2-15 to 2-20 below, wherein the award levels comprise a percentage value of the single progressive pool and a static minimum reward.

2-15. The method of any one or a combination of two or more of 2-11 to 2-14 above and 2-16 to 2-20 below, wherein the progressive pool processing system provides a seed reserve in addition to the progressive pool.

2-16. The method of any one or a combination of two or more of 2-11 to 2-15 above and 2-17 to 2-20 below, wherein a seed rake is removed from the wager value, a provider commission is removed from the wager value and a remaining value of the wager value is applied to the single progressive pool.

2-17. The method of any one or a combination of two or more of 2-11 to 2-16 above and 2-18 to 2-20 below, wherein the seed reserve is capped at a predetermined value.

2-18. The method of any one or a combination of two or more of 2-11 to 2-17 above and 2-19 to 2-20 below, wherein the progressive pool processing system is configured to extract a predetermined commission value from at least one of the wager value, the single progressive pool, and the reward value.

2-19. The method of any one or a combination of two or more of 2-11 to 2-18 above and 2-20 below, wherein the single progressive pool is partitioned into a plurality of tier levels.

2-20. The method of any one or a combination of two or more of 2-11 to 2-19 above, wherein each award level includes a plurality of award rates corresponding to each of the plurality of tier levels, such that the determination of the reward value includes a value from each of the plurality of tier levels determined by the plurality of award rates for the award level.

2-21. A gaming system comprising:
a gaming server in communication one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on partitioned award levels from a single progressive pool; and
determine a reward value for the gameplay request using the partitioned award levels and a progressive pool processing system;
wherein the partitioned award levels include at least a dynamic value based on the single progressive pool of the progressive pool processing system.

2-22. The gaming system of any one or a combination of two or more of 2-21 above and 2-23 to 2-31 below,
wherein the gameplay request comprises at least a wager value, and
wherein a provider commission is removed from the wager value and a remaining value of the wager value is applied to the single progressive pool.

2-23. The gaming system of any one or a combination of two or more of 2-21 to 2-22 above and 2-24 to 2-31 below, wherein the award levels comprise a percentage value of the single progressive pool.

2-24. The gaming system of any one or a combination of two or more of 2-21 to 2-23 above and 2-25 to 2-31 below, wherein the award levels comprise a percentage value of the single progressive pool and a static minimum reward.

2-25. The gaming system of any one or a combination of two or more of 2-21 to 2-24 above and 2-26 to 2-31 below, wherein the progressive pool processing system provides a seed reserve in addition to the progressive pool.

2-26. The gaming system of any one or a combination of two or more of 2-21 to 2-25 above and 2-27 to 2-31 below, wherein a seed rake is removed from the wager value, a provider commission is removed from the wager value and a remaining value of the wager value is applied to the single progressive pool.

2-27. The gaming system of any one or a combination of two or more of 2-21 to 2-26 above and 2-28 to 2-31 below, wherein the seed reserve is capped at a predetermined value.

2-28. The gaming system of any one or a combination of two or more of 2-21 to 2-27 above and 2-29 to 2-31 below, wherein the progressive pool processing system is configured to extract a predetermined commission value from at least one of the wager value, the single progressive pool, and the reward value.

2-29. The gaming system of any one or a combination of two or more of 2-21 to 2-28 above and 2-30 to 2-31 below, wherein the single progressive pool is partitioned into a plurality of tier levels.

2-30. The gaming system of any one or a combination of two or more of 2-21 to 2-29 above and 2-31 below, wherein each award level includes a plurality of award rates corresponding to each of the plurality of tier levels, such that the determination of the reward value includes a value from each of the plurality of tier levels determined by the plurality of award rates for the award level.

2-31. The gaming system of any one or a combination of two or more of 2-21 to 2-30 above, wherein the award levels comprise a percentage value of the single progressive pool and a static minimum reward.

2-32. A storage device having instructions stored thereon, which, when executed by one or more processors of a gaming system, configure the one or more processors to perform the method of any one or a combination of two or more of 2-11 to 2-20 above.

2-33. A gaming device comprising:
a memory; and
a processor
the gaming device being configured to communicate with one or more gameplay stations through a communications interface,
the gaming device configured to execute instructions stored on the memory to perform the following steps:
receiving a gameplay request from at least one of the one or more gameplay stations;
evaluating the gameplay request based on partitioned award levels from a single progressive pool; and
determining a reward value for the gameplay request using the partitioned award levels and a progressive pool processing system;
wherein the partitioned award levels include at least a dynamic value based on the single progressive pool of the progressive pool processing system.

2-34. The gaming device according to 2-33, wherein the gaming device itself is a gameplay station in communication with other gameplay stations.

2-35. A gaming device comprising:
a memory;
a processor; and
a user interface;
wherein the gaming device is configured to execute instructions stored on the memory to perform the following steps:
receive a gameplay request;
evaluate the gameplay request based on partitioned award levels from a single progressive pool; and
determine a reward value for the gameplay request using the partitioned award levels and a progressive pool processing system;
wherein the partitioned award levels include at least a dynamic value based on the single progressive pool of the progressive pool processing system.

1. A gaming system comprising:
one or more gameplay stations, the gameplay stations including a user interface; and
a gaming server in communication with the one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on partitioned award levels from one or more progressive pool(s); and
determine a reward value for the gameplay request using the partitioned award levels and a progressive pool processing system;
wherein the partitioned award levels include at least a dynamic value based on the one or more progressive pool(s) of the progressive pool processing system.

2. The gaming system of claim 1,
wherein the gameplay request comprises at least a wager value, and
wherein a provider commission is removed from the wager value and a remaining value of the wager value is applied to the one or more progressive pool(s).

3. The gaming system of claim 1, wherein the award levels comprise a percentage value of the one or more progressive pool(s).

4. The gaming system of claim 1, wherein the award levels comprise a percentage value of the one or more progressive pool(s) and a static minimum reward.

5. The gaming system of claim 1, wherein the progressive pool processing system provides a seed reserve in addition to the progressive pool.

6. The gaming system of claim 1, wherein a seed rake is removed from the wager value, a provider commission is removed from the wager value and a remaining value of the wager value is applied to the one or more progressive pool(s).

7. The gaming system of claim 5, wherein the seed reserve is capped at a predetermined value.

8. The gaming system of claim 1, wherein the progressive pool processing system is configured to extract a predetermined commission value from at least one of the wager value, the one or more progressive pool(s), and the reward value.

9. The gaming system of claim 1, wherein the one or more progressive pool(s) is partitioned into a plurality of tier levels.

10. The gaming system of claim 9, wherein each award level includes a plurality of award rates corresponding to each of the plurality of tier levels, such that the determination of the reward value includes a value from each of the plurality of tier levels determined by the plurality of award rates for the award level.

11. A method for conducting games, comprising:
receiving a gameplay request from one or more gameplay stations;
evaluating the gameplay request based on partitioned award levels from one or more progressive pool(s); and
determining a reward value for the gameplay request using the partitioned award levels and a progressive pool processing system;
wherein the partitioned award levels include at least a value based on the one or more progressive pool(s) of the progressive pool processing system.

12. The method of claim 11, wherein the gameplay request comprises at least a wager value, and
wherein a provider commission is removed from the wager value and a remaining value of the wager value is applied to the one or more progressive pool(s).

13. The method of claim 11, wherein the award levels comprise a percentage value of the one or more progressive pool(s).

14. The method of claim 11, wherein the award levels comprise a percentage value of the one or more progressive pool(s) and a static minimum reward.

15. The method of claim 11, wherein the progressive pool processing system provides a seed reserve in addition to the progressive pool.

16. The method of claim 11, wherein a seed rake is removed from the wager value, a provider commission is removed from the wager value and a remaining value of the wager value is applied to the one or more progressive pool(s).

17. The method of claim 15, wherein the seed reserve is capped at a predetermined value.

18. The method of claim 11, wherein the progressive pool processing system is configured to extract a predetermined commission value from at least one of the wager value, the one or more progressive pool(s), and the reward value.

19. The method of claim 11, wherein the one or more progressive pool(s) is partitioned into a plurality of tier levels.

20. The method of claim 19, wherein each award level includes a plurality of award rates corresponding to each of the plurality of tier levels, such that the determination of the reward value includes a value from each of the plurality of tier levels determined by the plurality of award rates for the award level.

21. A storage device having instructions stored thereon, which, when executed by one or more processors of a gaming system, configure the one or more processors to perform the method according to claim 11.
